(19) United States
(12) Patent Application Publication
(10) Pub. No.: US 2008/0040451 A1
(43) Pub. Date: Feb. 14, 2008

(54) System and Method for Verifying User and Provider Information Data Delivery

(76) Inventor: Chuck Manning, Winterville, NC (US)

Correspondence Address: FAY KAPLUN & MARCIN, LLP, 15O BROADWAY, SUITE 702, NEW YORK, NY, 10038, US

(21) Appl. No.: 11/693,884

(22) Filed: Mar. 30, 2007

Related U.S. Application Data
(63) Continuation-in-part of application No. 11/693,048, filed on Mar. 29, 2007.

(30) Foreign Application Priority Data
Aug. 10, 2006 (GB) 0615857.0

(51) Int. Cl. G06F 15/16

(52) U.S. Cl. 709/219

(57) ABSTRACT

A system and method for receiving a content request for content from a content provider, the request including a content provider identification identifying the content provider and a content identification identifying the content, validating the content provider based on the content provider identification, validating the content based on the content identification and storing, after successful validation of the content provider and the content, transaction details corresponding to the content request.

### INCORPORATION BY REFERENCE

This application is a continuation-in-part of and claims priority to U.S. application Ser. No. 11/693,048 entitled “Data Delivery” filed on Mar. 29, 2007 and GB Patent Application Serial No. 0615857.0 entitled “Data Delivery” and filed on Aug. 10, 2006, both of which are incorporated by reference herein, in their entirety.

### BACKGROUND INFORMATION

Under a traditional client-server model for a content delivery system, a server stores multiple data structures and each client obtains a data structure from the server. The client-server model has the advantage that access to various data structures can easily be controlled using the server. However, this model also has the disadvantage that the bandwidth of the network connection to the server must increase dramatically as the number of clients and stored data structures increases.

Under a traditional peer-to-peer (“P2P”) model for a content delivery system, a peer (operating as a client) downloads a data structure from another peer (operating as a server), and then operates as a server for the downloaded data structure. This model has the advantage of eliminating the bandwidth bottleneck present under a traditional client-server content delivery model. However, it also has the added disadvantage that access to a data structure, once released onto the P2P network, is not controlled.

### SUMMARY OF THE INVENTION

A method for receiving a content request for content from a content provider, the request including a content provider identification identifying the content provider and a content identification identifying the content, validating the content provider based on the content provider identification, validating the content based on the content identification and storing, after successful validation of the content provider and the content, transaction details corresponding to the content request.

A method for receiving a content request for content from a user, the request including a user identification and a content identification identifying the content, validating the user based on the user identification, generating a further content request for the content, the request including a content provider identification identifying the content provider and the content identification identifying the content and transmitting the further content request.

A system having a content provider receiving a content request for content from a user, the request including a user identification and a content identification identifying the content, validating the user based on the user identification, generating a further content request for the content, the request including a content provider identification identifying the content provider and the content identification identifying the content and transmitting the further content request and an administrator receiving the further content request from the content provider, validating the content provider based on the content provider identification, validating the content based on the content identification and storing, after successful validation of the content provider and the content, transaction details corresponding to the content request.

### BRIEF DESCRIPTION OF DRAWINGS

FIG. 1 shows a schematic illustration of an exemplary data delivery system according to the present invention.

FIG. 2 shows an exemplary fragmentation process according to the present invention.

FIG. 3 shows an exemplary defragmentation process according to the present invention.

FIG. 4 shows a schematic illustration of an exemplary record according to the present invention.

FIG. 5 shows an exemplary method by which a distribution apparatus provides information to an administrator apparatus according to the present invention.

FIG. 6 shows a schematic illustration of an exemplary apparatus operable as a requester apparatus, a distribution apparatus, an administration apparatus, and a data provider apparatus according to the present invention.

FIG. 7 illustrates an exemplary system embodying a computer program according to the present invention.

FIG. 8 shows a first exemplary process for user authentication for access to non-paid content according to the present invention.

FIG. 9 shows a second exemplary process for user authentication for access to non-paid content according to the present invention.

FIG. 10 shows a first exemplary process for user authentication for access to paid content according to the present invention.

FIG. 11 shows a second exemplary process for user authentication for access to paid content according to the present invention.

### DETAILED DESCRIPTION

The present invention may be further understood with reference to the following description and the appended drawings, wherein like elements are referred to with the same reference numerals. The exemplary embodiments of the present invention provide a digital content delivery system that combines advantages of both traditional client-server and P2P systems. Content is fragmented by an administration apparatus and stored at multiple distribution apparatuses. When the content is requested, access is controlled by the administration apparatus, which provides information to the requesting apparatus enabling access to the distribution apparatuses. Once the content has been reassembled at the requesting apparatus, it may also become a distribution apparatus for part of the content.

Thus, unlike traditional P2P networks, the exemplary embodiments of the present invention provide for a centralized control system for the distribution of content. This means that the content providers, rather than the users, control the data that enters the P2P network. The centralized control system also ensures that the content is not renamed, modified or tampered with throughout the network. It should also be noted that the exemplary embodiments of the present invention provide for the both the distribution of static data (e.g., music files, movie files, etc.) and streaming data such as webcasts, etc. via the P2P network.

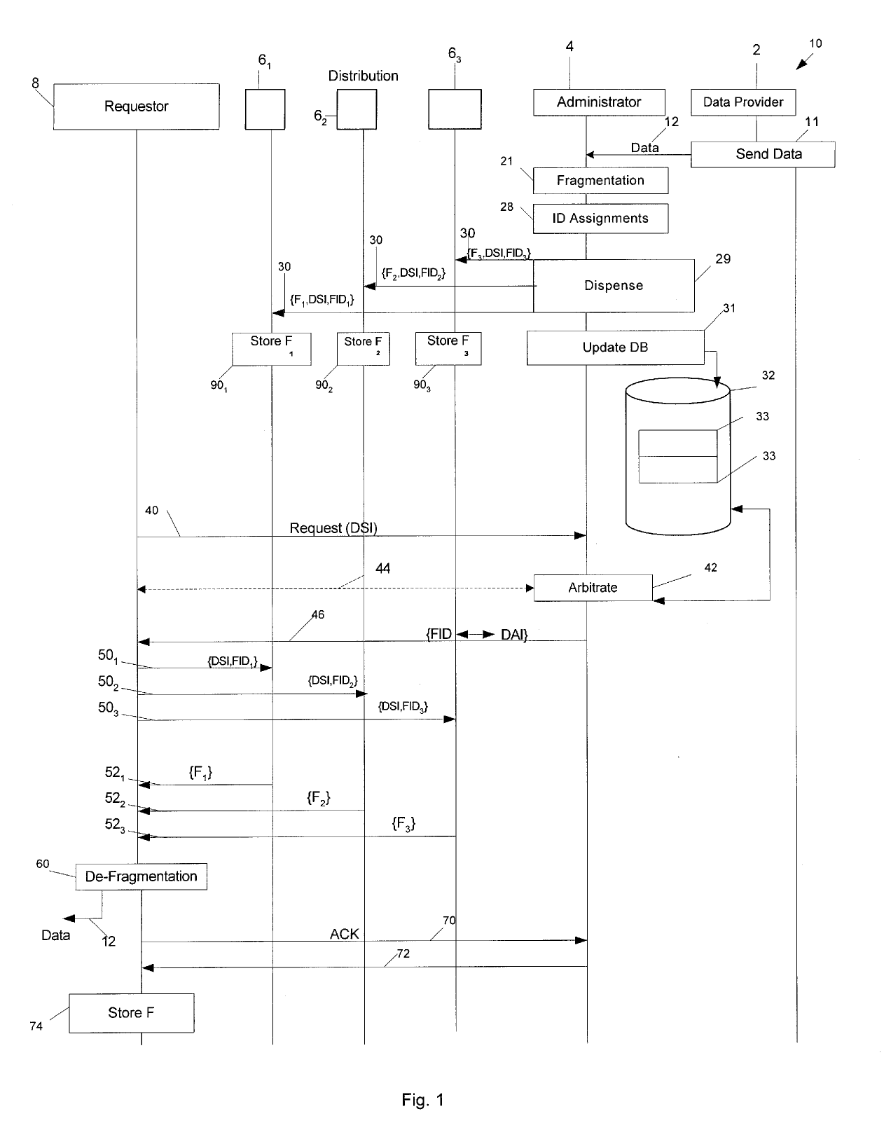

FIG. 1 schematically illustrates a data delivery system 10. The system comprises a data provider apparatus 2, an administrator apparatus 4, distribution apparatuses 61, 62, 63, and a requestor apparatus 8. The different apparatuses may communicate via a data network such as the Internet, a Wide Area Network (WAN), a Local Area Network (LAN) etc. The data provider apparatus 2 sends, at block 11, a first data structure 12 to the administrator apparatus 4. The first data structure 12 may be any suitable collection of data. It may, for example, be a film, a music track, an image, a database, etc. The administrator apparatus 4 fragments, at block 21, the first data structure 12, creating a set of N of data fragments F₁, F₂, F₃ . . . F_{N}. It should be apparent that the value of N may be fixed or may vary with different data structures. In one implementation of the present invention, there may be a minimum value for N (e.g., ten) which is set to apply to all data structures 12.

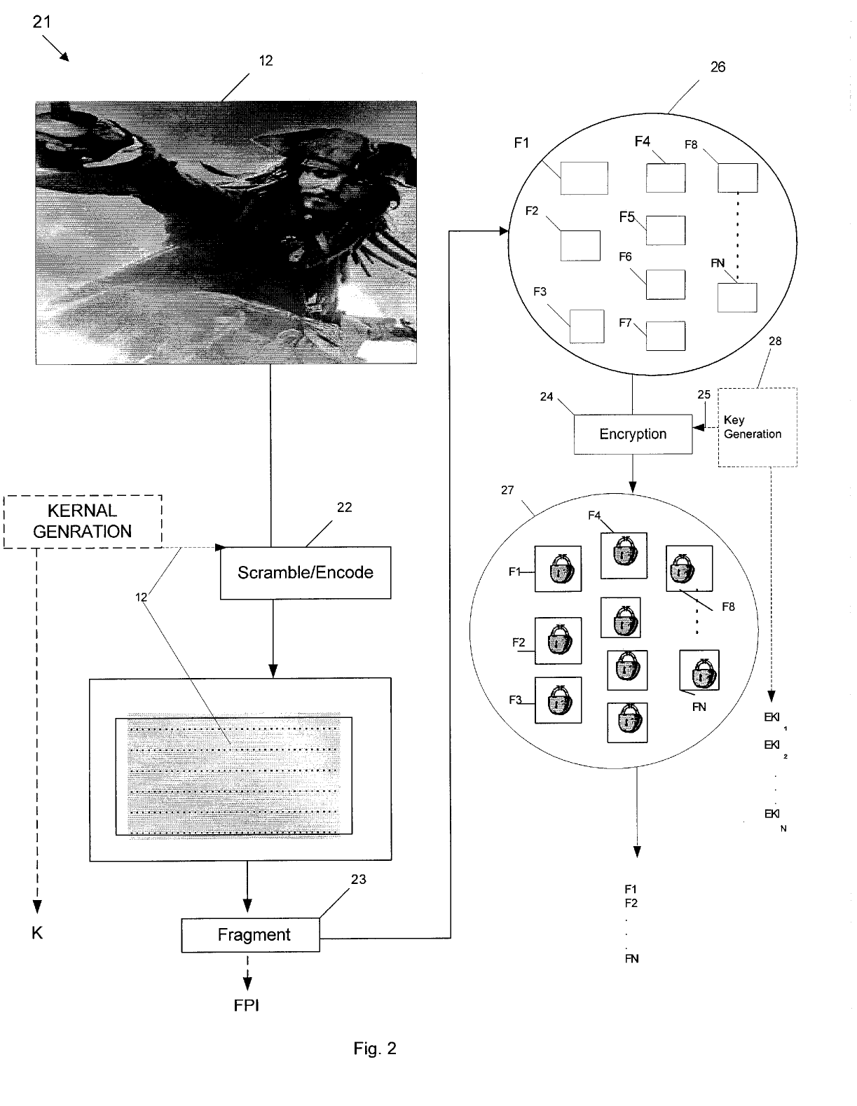

One example of the fragmentation process 21 is illustrated in FIG. 2. A subject data structure 12 is scrambled (or otherwise encoded) at block 22 to create a scrambled/encoded data structure 12′. The scrambling occurs in a predetermined manner (e.g., by changing the position/order of data portions within the data structure 12). The scrambling process may use a different randomly generated kernel K for each data structure 12. Next, the scrambled data structure 12′ is fragmented at block 23 into a set 26 of N non-overlapping independent data portions or fragments F₁, F₂, F₃ . . . F_{N} according to a predetermined fragmenting procedure. In some implementations, a number of different fragmenting procedures may be used, each of which can be identified by a different fragmenting procedure identifier (“FPI”).

In some implementations, the output of the fragmentation process 21 is the output of the fragmenting procedure 23. In other implementations, the output of the fragmenting procedure 23 is encrypted to become the output of the fragmentation process 21. The data fragments F₁, F₂, F₃ . . . F_{N} are separately encrypted at block 24. In some implementations, the same encryption process may be used for all data fragments F. In other implementations, a different encryption key 25 may be used for encrypting each data fragment F. The keys may be generated in key generation block 28 and each key may be identified by an encryption key identifier (“EKI”). The EKI may be the key itself or an address in a look-up table listing the keys. In one exemplary implementation, the data fragments F may be encrypted using 256-bit AES (Advanced Encryption Standard) encryption using a unique key for each data fragment F. The encryption block 24 produces a set 27 of N encrypted data fragments F.

Referring back to FIG. 1, next, at block 28, a unique data structure identifier (“DSI”) is assigned to the received data structure 12 and a different fragment identifier FIDᵢ is assigned to each of the fragments Fᵢ. Thus, any fragment Fᵢ of a data structure 12 may be uniquely referenced by the combination of a DSI and an FIDᵢ. Next, at block 29, the fragments F are dispersed amongst a plurality M of distribution apparatuses 6. A distribution apparatus 6 may store only m fragments of a particular data structure, where m<N. In one implementation, m is one. Each distribution apparatus 6 has its own apparatus identifier (“Al”) which may be, for example, an Internet protocol (IP) address. The fragments F may be dispersed by sending a message 30 to each of the M distribution apparatuses.

The administrator apparatus 4, at block 31, updates a database 32. The database 32 has a separate record 33 for each data structure 12 and the record 33 may be addressed using the assigned data structure identifier (“DSI”). A record 33 is a data structure used to store information concerning a subject data structure 12 and it enables a remote requesting apparatus 8 to create the originally received subject data structure 12 from dispersed fragments F of the data structure 12, as will be discussed in further detail below.

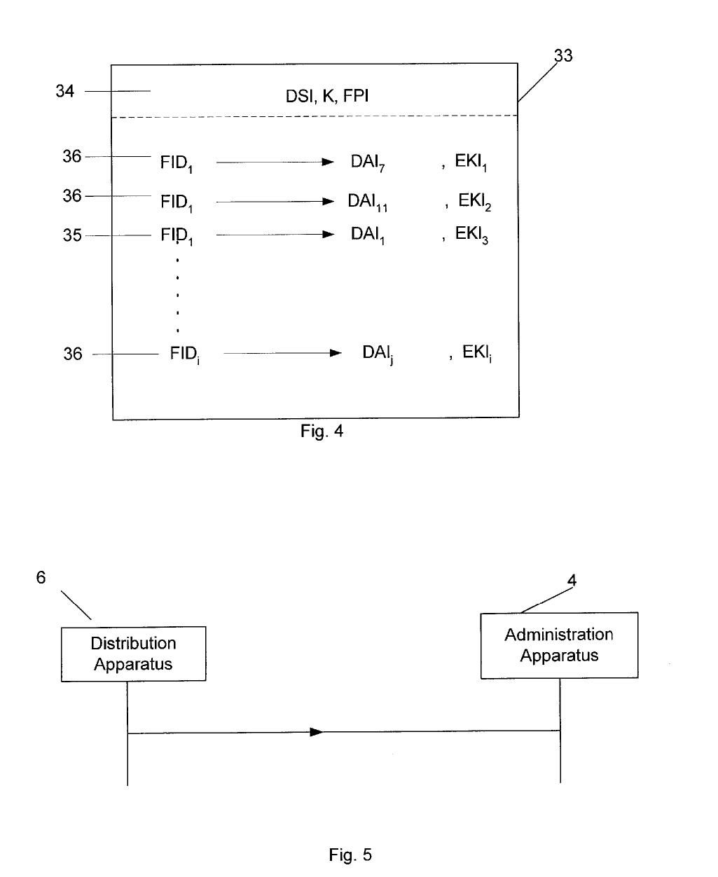

One example of a record is schematically illustrated in FIG. 4. A record 33 may have a header 34 that comprises its associated DSI and, if used, the scrambling kernel K and FPI associated with the production of fragments F from the subject data structure 12. The record 33 may have a body 35 that has a plurality of entries 36. An entry 36 is used to map an FIDᵢI, for the associated data structure 12, to a distribution apparatus identifier or identifiers (“DAI”) to which that fragment is dispersed. If a data fragment Fᵢ has been independently encrypted before dispersal, as previously discussed in step 24, then the entry 36 for that fragment will also associate with the FID for that fragment the correct EKI that is or identifies the encryption key used to encrypt/decrypt the fragment.

Referring back to FIG. 1, a message 30 contains a fragment Fᵢ, and a fragment address that enables any requester apparatus 8 to access that data fragment after dispersal. A suitable fragment address is the combination of the DSI associated with the data structure 12 and the FID associated with the fragment. A distribution apparatus 6, on receiving a message 30, extracts the content of the message and stores the data fragment F received in the message at block 90 in a manner that allows it to be referenced by the fragment address. In one implementation, the number of fragments N is the same as the number M of distribution apparatuses 8 amongst which the fragments are dispersed, and each distribution apparatus may store only one fragment of a particular data structure 12. Although a distribution apparatus 8 may store multiple fragments, they will relate to different data structures, as the distribution apparatus may store only one fragment of a particular data structure 12. However, in other exemplary embodiments, it may be possible that a single distribution apparatus may store multiple fragments M of the same file.

It should be appreciated that the same or a different data provider 2 may provide a second data structure 12 to the administrator apparatus 4, which will in turn fragment that second data structure and disperse those second fragments amongst distribution apparatuses 6, which may or may not include the distribution apparatuses over which the first fragments of the first data structure 12 were dispersed. The database 32 is updated to include a new record 33 for the second data structure as described above.

The process of data retrieval by a requester apparatus 8 will now be described. The requester apparatus 8 requests a particular data structure 12 by sending a request 40 to the administrator apparatus 4. The request 40 identifies the required data structure by, for example, including the DSI of the required data structure and also a requestor apparatus identifier (“RAI”), which may be, for example, an IP address. The administrator apparatus 4 receives the request 40 and arbitrates the request 40 at block 42. If arbitration is successful, the record 33 in the database 32 associated with the requested data structure is accessed and it or a portion of it is sent to the requester apparatus 8 as message 46.

The arbitration process 42 may include an authentication procedure and/or a payment procedure. For example, in a membership implementation, the RDI received in the request may be compared against a membership log to check whether the requester apparatus 8 is authorized to have access to the requested data structure. As another example, in a shop-front implementation, receipt of the request may initiate a payment procedure by which a payment is made from the requester apparatus 8 to the administrator apparatus 4. The arbitration process 42 may also involve the creation 44 of a secure communication channel between the requestor apparatus 8 and the administrator apparatus 4. In one embodiment, this may be achieved by including, within the request 40, the public key of the requestor apparatus 8, generating an encryption key at the administrator apparatus 4, encrypting the generated key with the public key, and sending the result to the requestor apparatus 8. The requestor apparatus 8 uses its own secret private key to recover the generated encryption key from the received result. The generated encryption key may then be used to encrypt information from the record 33 before it is transmitted to the requester apparatus 8 as message 46 and used at the requestor apparatus 8 to recover the original information from the record 33.

The received record information identifies a plurality of distribution apparatuses 6 and the data fragments F of the requested data structure 12 that are stored at those apparatuses. For example, the received information may include the mappings of FID to DAI discussed in relation to FIG. 4. The requester apparatus 8 creates a fragment access request 50 for each of the identified distribution apparatuses 6. A fragment access request 50 includes a fragment address which may be a combination of a DSI and a FIDI. The multiple fragment access requests 50 created may be sent in parallel to the respective distribution apparatuses 6.

A distribution apparatus 6 responds to receipt of a fragment access request 50 by accessing the stored fragment F identified by the fragment address in the request 50 and returning, in a reply message 52, the accessed fragment F to the requestor apparatus 8 from which the fragment access request 50 was received. In the implementation where N=M and m=1, N fragment access requests are created and sent to the N distribution apparatuses, which return N fragments. The fragments F received by the requestor apparatus 8 are used, in block 60, to recreate the original data structure 12 in a de-fragmentation process 5, which is the reverse of the fragmentation process 21.

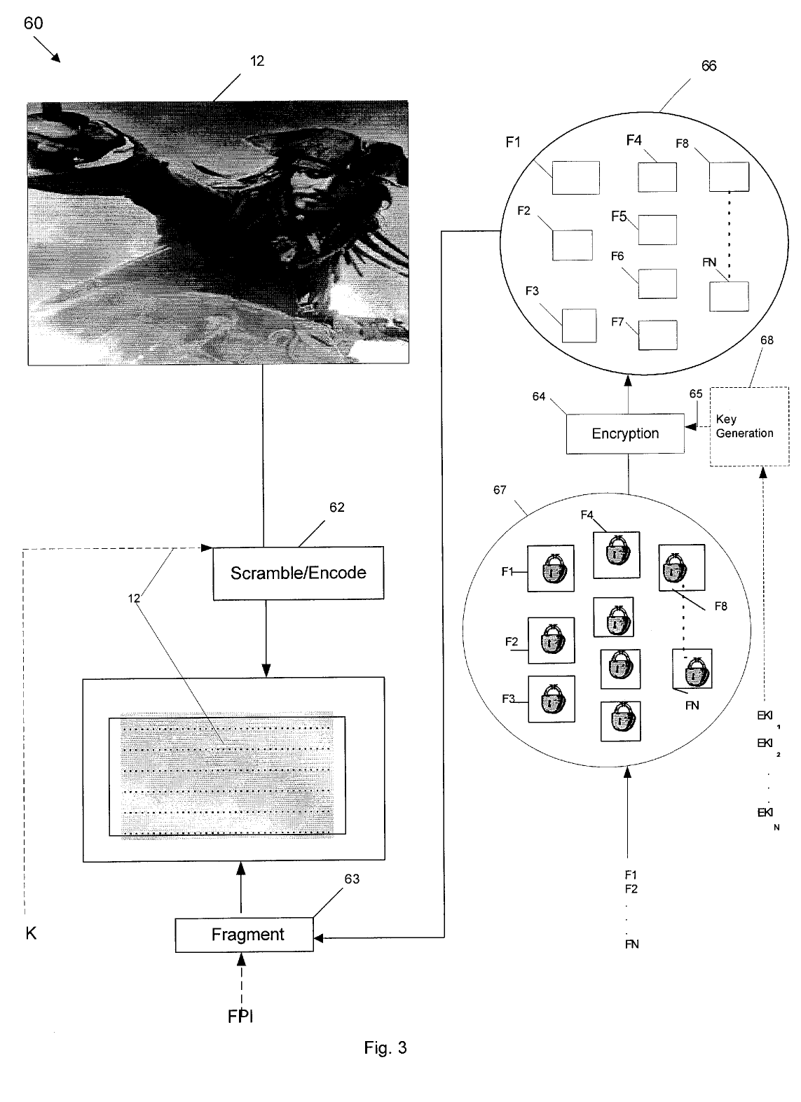

If the process illustrated in FIG. 2, was used for fragmentation, the process illustrated in FIG. 3 may be used for de-fragmentation. A set 67 of N encrypted data fragments F are provided to decryption block 64. The data fragments F₁, F₂, F₃ . . . F_{N} are separately decrypted at block 64 to produce a set 66 of N scrambled data fragments F. In some implementations, the same decryption process may be used for all data fragments F. In other implementations, a different decryption key 65 may be used for decrypting each data fragment F. A key for a particular fragment Fᵢ may be generated in key generation block 68 using the encryption key identifier (EKIᵢ) for that fragment, obtained from the received record 33. Next the set 66 of N (scrambled) data fragments F are de-fragmented at block 63 to create a scrambled data structure 12′. If a number of different de-fragmenting procedures are possible, the correct de-fragmentation procedure 63 is identified using an FPI from the received record 33. The scrambled data structure 12′ is de-scrambled (or decoded) at block 62 to re-create the subject data structure 12. The descrambling occurs in a predetermined manner (e.g. by changing the position/order of data portions within the data structure 12). If the de-scrambling process uses a different randomly generated kernel K for each data structure 12, the correct K is taken from the received record 33. Thus the original data structure 12 is recovered from a plurality of fragments dispersed over a number of distribution apparatuses 6.

Returning to FIG. 1, after de-fragmentation 60, the original data structure 12 is available in the requestor apparatus 8 for use. Other actions with respect to the data structure 12 may be restricted. For example, storage of the data structure 12 may or may not be permitted. If storage is allowed it may only be allowed in a manner that prevents access by a third party or distribution to a third party. Copying, distribution, etc. of the data structure may or may not be permitted. When the original data structure 12 has been successfully created from the fragments F, which may be verified using a checksum or similar, the requester apparatus 8 sends an acknowledgement message 70 to the administrator apparatus 4 indicating that the data structure 12 has been successfully assembled from the dispersed fragments F.

The administrator apparatus 4 may respond to the received acknowledgement by sending a command 72 that instructs the requestor apparatus 8 to store a sub-set n of the N fragments it received and assembled to create the data structure 12 and to operate as a distribution apparatus 6 with respect to those n fragments. In one implementation, the value of n is always one. The requestor apparatus 8, on receiving the command 72, stores the data fragment(s) F identified in the command at block 74 in a manner that allows the data fragment(s) to be referenced by subsequently received fragment address(es). The administrator apparatus 4, at block 76, updates the database 32 to include an additional or replacement entry or entries 36 in the record 33 for the subject data structure 12. The new entry or entries 36 map the requester apparatus 8 to the fragment or fragments of the subject data structure 12 stored on that requester apparatus 8. Thus when a further requester apparatus requests the same data structure 12, the procedure is the same as described above for FIG. 1, except that the further requester apparatus operates as the ‘requestor apparatus 8’ and the original requester apparatus may operate as one of the distribution apparatuses 6.

Thus, the exemplary embodiments of the present invention offer multiple layers of security for the content provided by content providers on the P2P network. As shown above, each file is fragmented into multiple fragments. Each fragment may be of a random size so that users (or others) are not aware of the properties of the fragments. The fragments are sent to multiple distribution apparatuses 6 so that, in a preferred embodiment, no one single distribution apparatus 6 has more than one fragment from an individual file. In addition, the distribution of the fragments to the various distribution apparatuses 6 may be randomized so that, for example, the fragments are not sent out to distribution apparatuses 6 in IP address order, or any other discernable order. Moreover, each fragment may be uniquely encrypted so that even in the unlikely event that a single fragment was maliciously unencrypted, it would only be a small fraction of the entire file and would likely be unusable. In addition, when the data is stored on the user's devices (e.g., the distribution apparatuses 6), the data is not visible in its native/raw format. For example, if a music file is stored as an MP3 file, the format of any of the fragments of the MP3 file is not the MP3 format.

Another layer of security of the exemplary embodiments where copying, distribution, etc. of the data structure 12 by the requestor apparatus 8 is desired to be limited, this limitation may be achieved by data binding. Upon completion of a successful download to the requester apparatus 8, the data structure 12 is encrypted a final time and is only stored in its encrypted format on the requester apparatus 8. This encryption ties or binds a version of the downloaded file directly to the end user's machine (e.g., the requestor apparatus 8) such that the end user cannot copy the file to another device. The encrypted file may be in a proprietary format. Those skilled in the art will understand that there are many types of proprietary encrypted formats and that the present invention may be implemented using any of these formats.

In one exemplary implementation, network binding may be used. In a network binding implementation, the binding credentials (i. e. encryption keys) are stored by the administrator apparatus 4; the requestor apparatus 8 contacts the administrator apparatus 4 to obtain credentials each time data structure 12 is accessed. This provides a high level of security but requires the requester apparatus 8 to have an active network connection each time the requestor apparatus 8 desires to access the data structure 12.

In another exemplary implementation, local binding may be used. In the local binding implementation, the binding credentials are stored locally on the requester apparatus 8. This provides less security than a network binding implementation, but is more convenient for users of the requestor apparatus 8 because a network connection is not required each time data structure 12 is to be accessed.

Another layer of security provided by the exemplary embodiments is the restriction of only authorized users to the content provided by content providers. The content (e.g., data structure 12) may be either paid (i.e., the user is required to pay to gain access to the content) or non-paid (i.e., the user may access to the content without charge). However, in either case, the content provider desires to maintain the integrity of the content by making the content available to only authorized users. The following will provide exemplary embodiments for user authentication for access to the content.

FIG. 8 shows a first exemplary process 200 for user authentication for access to non-paid content. In this exemplary embodiment, the steps performed by the user are shown in the client box 210, the steps performed by the content provider are shown in the provider box 220 and the steps performed by the P2P administrator are shown in the administrator box 230. The content provider is the data provider 2 shown in FIG. 1, the P2P administrator is the administrator 4 shown in FIG. 1 and the user is the requester 8 shown in FIG. 1.

In a first step 250, the user connects to the content provider by, for example, logging into a web page of the content provider. The user may login using any known login process that is implemented by the content provider. The login request from the user may also include a content request that includes information such as a user ID, a content ID (i.e., an identification of the particular content that the user desires to access), etc. In step 252, the content provider receives the login information and the content request from the user and determines if the user is a valid user (step 254). If the user is not a valid user, the content provider sends an error message that is received by the user and the connection is terminated (step 256). If the user is a valid user, the content provider generates a unique transaction ID for this content request of the user (step 258). The content provider then transmits the transaction ID, provider credentials and the content ID to the administrator (step 260). The provider credentials may be unique information that identifies the content provider to the administrator. These provider credentials may only be known to the content provider and the administrator. As will be seen in greater detail below, use of the provider credentials in the communications between the content provider and the administrator alleviates the need for the user's information to be passed along to the administrator. Thus, the content provider may be able to assure the user that their private login information remains with the content provider and is not provided to any external party such as the administrator.

In step 262, the administrator receives the information from the content provider and determines if the content request is valid. The administrator may include a database or series of databases (or other storage mechanism) for storing information on the various content providers that subscribe to the service provided by the administrator. For example, in step 264, the administrator may compare the received provider credentials to a list of valid provider credentials in a provider credential database. In step 266, the administrator may compare the received content ID to a list of valid content for the identified content provider in a provider content database. In step 268, the administrator may compare the received transaction ID to a list of valid transaction IDs for the content provider in a provider transaction database.

Those skilled in the art will understand that the administrator may populate the various databases used to validate requests in any number of manners. For example, each time a new content provider signs up for the administrator's service, the administrator may generate unique provider credentials for the content provider, send these unique provider credentials to the content provider and store the credentials in the provider credential database for future validation. The administrator may periodically send new provider credentials to each content provider to assure that the provider credentials have not been comprised. The corresponding updates will also be included in the provider credential database.

In another exemplary embodiment, the content provider sends the administrator the content (e.g., data structure 12) including the content ID. The administrator may then populate the provider content database with the content ID. The content provider may also include additional information such as stale dates (i.e., a date and/or time when the content is no longer valid or should no longer be distributed). The administrator may include this information in the provider content database so that the content ID may be de-populated or be marked as invalid when the condition occurs (e.g., the date and/or time has passed).

In another example, the content provider may periodically provide the administrator with a list of transaction IDs that the content provider will generate for valid transactions. The administrator may then store these transaction IDs in the provider transaction database to verify that the transaction ID is valid for the content provider. In another example, the content provider may provide the administrator with a set of rules for transaction IDs that will be generated by the content provider. If the transaction ID satisfies the rules that are stored by the administrator, it may be determined that the transaction ID is valid.

If any of the steps 264-268 results in an invalid request, the content provider is notified of the error and the connection between the content provider and the administrator is terminated (step 270). In turn, the user is notified of the error and the connection between the user and the content provider is terminated (step 256). If the content request is valid, the administrator stores the transaction details for further use (step 272). The transaction details may include the valid transaction ID and the content ID. The administrator then transmits the successful validation of the content request to the content provider (step 274). The content provider then sends the transaction ID to the user including a link to redirect the user to the administrator's site (step 276).

The user receives the transaction ID and is redirected to the administrator's site (step 278). When the user is redirected to the administrator site, the transaction ID is sent from the user to the administrator. In step 280, the administrator receives the transaction ID and compares the received transaction ID to the previously stored transaction IDs (e.g., the transaction ID of the transactions details stored in step 272). If the received transaction ID does not match a valid pending transaction ID (step 282), the user is notified in step 284 and the connection to the administrator is terminated. If the transaction ID is validated (step 282), the administrator retrieves the download details and transmits a message (e.g., message 46 of FIG. 1) including the download details for the requested content to the user (step 286). The user receives the download details and then contacts the distribution apparatuses to begin download of the requested content (step 288).

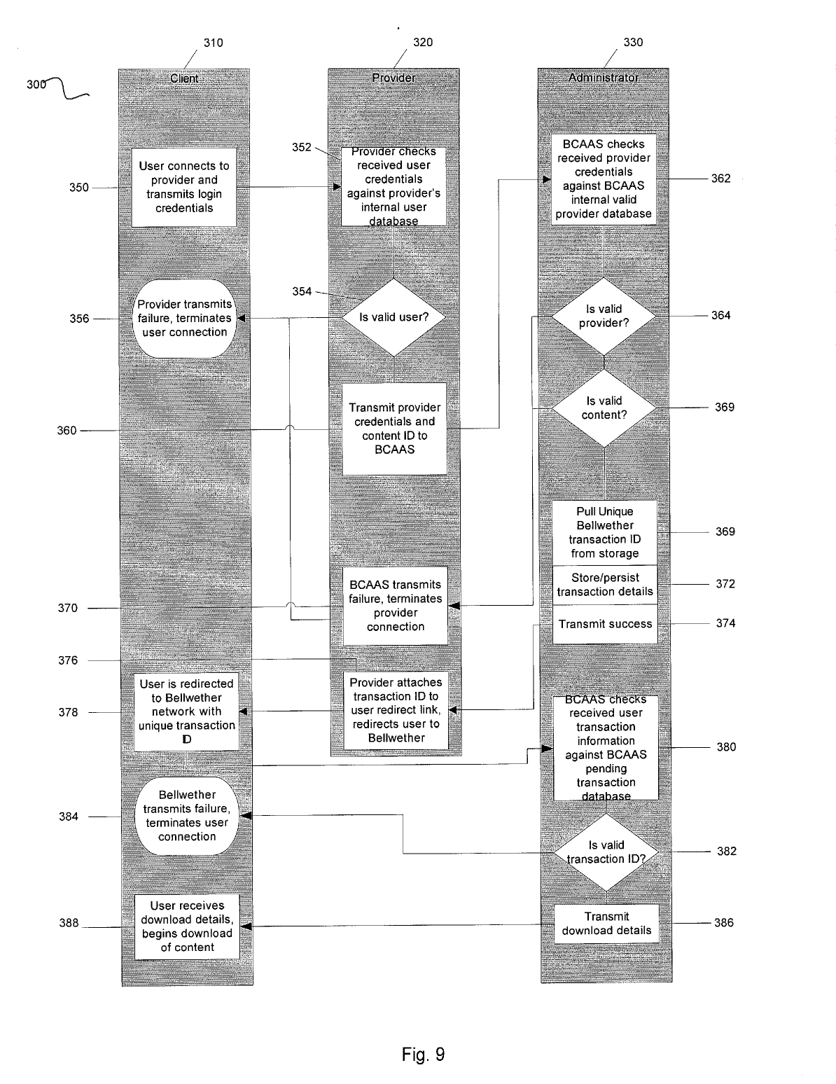

FIG. 9 shows a second exemplary process 300 for user authentication for access to non-paid content. In this exemplary embodiment, the steps performed by the user are shown in the client box 310, the steps performed by the content provider are shown in the provider box 320 and the steps performed by the P2P administrator are shown in the administrator box 330. The content provider is the data provider 2 shown in FIG. 1, the P2P administrator is the administrator 4 shown in FIG. 1 and the user is the requester 8 shown in FIG. 1. The steps of process 300 are generally similar to the steps of the process 200 having corresponding numbers (e.g., step 250 of process 200 is generally similar to step 350 of process 300). Thus, these steps will only be briefly described because additional information for these steps has been provided above. However, those steps that are different will be described in more detail.

In a first step 350, the user connects to the content provider. In step 352, the content provider receives the login information and the content request from the user and determines if the user is a valid user (step 354). If the user is not a valid user, the content provider sends an error message that is received by the user and the connection is terminated (step 356). If the user is a valid user, the content provider then transmits provider credentials and the content ID to the administrator (step 360). It is noted that in process 200, the content provider also generated a transaction ID and transmitted the transaction ID to the administrator. However, this step is omitted from the process 300.

In step 362, the administrator receives the information from the content provider and determines if the content request is valid. For example, in step 364, the administrator may compare the received provider credentials to a list of valid provider credentials in a provider credential database. In step 266, the administrator may compare the received content ID to a list of valid content for the identified content provider in a provider content database. If any of the steps 364-366 results in an invalid request, the content provider is notified of the error and the connection between the content provider and the administrator is terminated (step 370). In turn, the user is notified of the error and the connection between the user and the content provider is terminated (step 356).

If the content request is valid, in contrast to the process 200, the process 300 includes step 369 where the administrator assigns a unique transaction ID to the valid transaction. In one example, the administrator generates a unique 64 byte alphanumeric key for the transaction ID. The administrator then stores the transaction details for further use (step 372). The transaction details may include the valid transaction ID and the content ID. The administrator then transmits the successful validation of the content request to the content provider (step 374). The content provider then sends the transaction ID to the user including a link to redirect the user to the administrator's site (step 376).

The user receives the transaction ID and is redirected to the administrator's site (step 378). When the user is redirected to the administrator site, the transaction ID is sent from the user to the administrator. In step 380, the administrator receives the transaction ID and compares the received transaction ID to the previously stored transaction IDs (e.g., the transaction ID of the transactions details stored in step 372). If the received transaction ID does not match a valid pending transaction ID (step 382), the user is notified in step 384 and the connection to the administrator is terminated. If the transaction ID is validated (step 382), the administrator retrieves the download details and transmits a message (e.g., message 46 of FIG. 1) including the download details for the requested content to the user (step 386). The user receives the download details and then contacts the distribution apparatuses to begin download of the requested content (step 388).

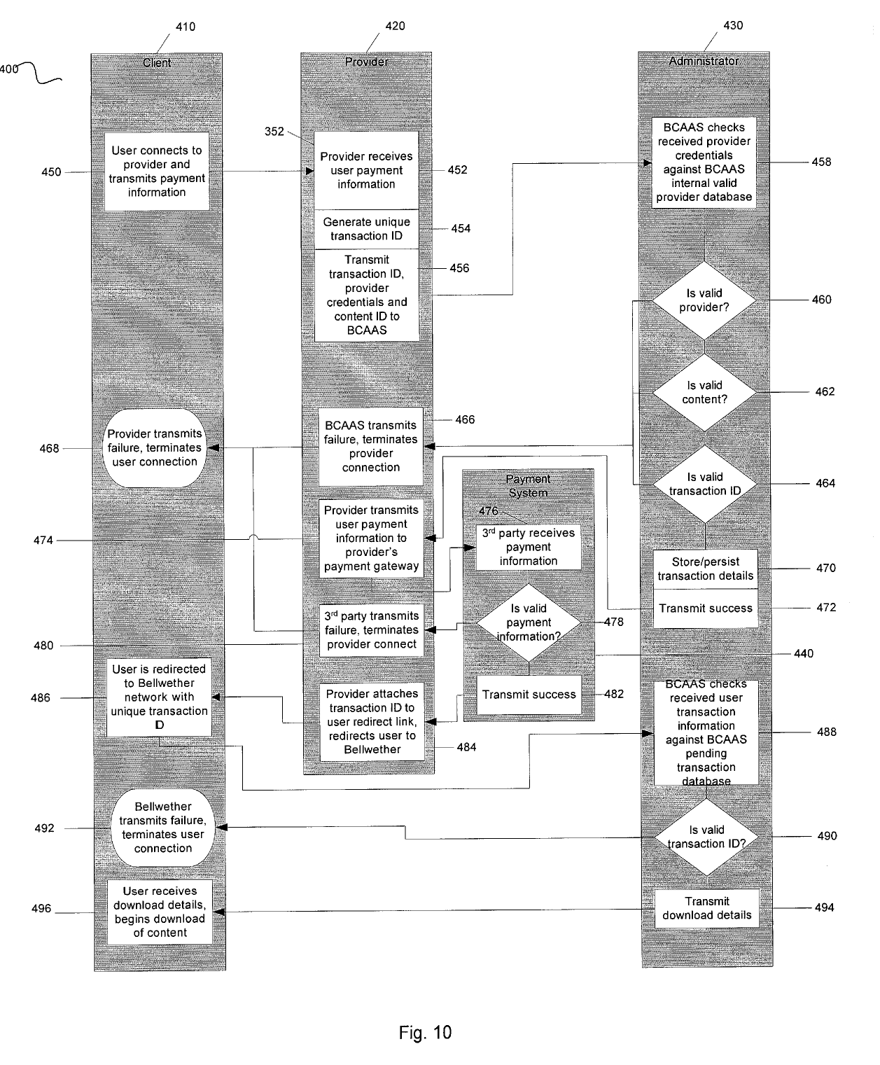

FIG. 10 shows a first exemplary process 400 for user authentication for access to paid content. In this exemplary embodiment, the steps performed by the user are shown in the client box 410, the steps performed by the content provider are shown in the provider box 420, the steps performed by the P2P administrator are shown in the administrator box 430 and the steps performed by a third party payment system are shown in payment system box 440. The content provider is the data provider 2 shown in FIG. 1, the P2P administrator is the administrator 4 shown in FIG. 1 and the user is the requester 8 shown in FIG. 1. The third party payment system is not shown in FIG. 1.

In a first step 450, the user connects to the content provider by, for example, accessing a web page of the content provider. The accessing of the web page may also include a content request that includes information such as a content ID (i. e., an identification of the particular content that the user desires to access) and payment information for the content such as credit card information. In step 452, the content provider receives the content request including the content ID and the payment information. In contrast to the above described non-paid content processes, the content provider does not need to determine if the user is a valid user because any user having a valid form of payment (as will be verified below) is considered a valid user. The content provider then generates a unique transaction ID for this content request of the user (step 454). The content provider then transmits the transaction ID, provider credentials and the content ID to the administrator (step 456).

In step 458, the administrator receives the information from the content provider and determines if the content request is valid. For example, in step 460, the administrator may compare the received provider credentials to a list of valid provider credentials in a provider credential database. In step 462, the administrator may compare the received content ID to a list of valid content for the identified content provider in a provider content database. In step 464, the administrator may compare the received transaction ID to a list of valid transaction IDs for the content provider in a provider transaction database.

If any of the steps 460-464 results in an invalid request, the content provider is notified of the error and the connection between the content provider and the administrator is terminated (step 466). In turn, the user is notified of the error and the connection between the user and the content provider is terminated (step 468). If the content request is valid, the administrator stores the transaction details for further use (step 470). The transaction details may include the valid transaction ID and the content ID. The administrator then transmits the successful validation of the content request to the content provider (step 472).

Upon receiving confirmation that the content request is valid, the content provider sends the payment information to the third party payment system (step 474). The third party payment system receives the payment information (step 476) and determines if the payment information is valid (step 478). The third party payment system may be, for example, a credit card clearing house that determines whether the credit card information is valid and that the user is approved for the transaction amount. In another example, the third party payment system may be a debit account (e.g., a PayPal account) or any other type of account that may be used for web based transactions.

If the payment information is invalid, the content provider is notified of the error and the connection between the content provider and the administrator is terminated (step 480). In turn, the user is notified of the error and the connection between the user and the content provider is terminated (step 468). If the payment information is valid, the third party payment system transmits a successful validation of the payment information to the content provider (step 482). The content provider then sends the transaction ID to the user including a link to redirect the user to the administrator's site (step 484).

The user receives the transaction ID and is redirected to the administrator's site (step 486). When the user is redirected to the administrator site, the transaction ID is sent from the user to the administrator. In step 488, the administrator receives the transaction ID and compares the received transaction ID to the previously stored transaction IDs (e.g., the transaction ID of the transactions details stored in step 470). If the received transaction ID does not match a valid pending transaction ID (step 490), the user is notified in step 492 and the connection to the administrator is terminated. If the transaction ID is validated (step 490), the administrator retrieves the download details and transmits a message (e.g., message 46 of FIG. 1) including the download details for the requested content to the user (step 494). The user receives the download details and then contacts the distribution apparatuses to begin download of the requested content (step 496).

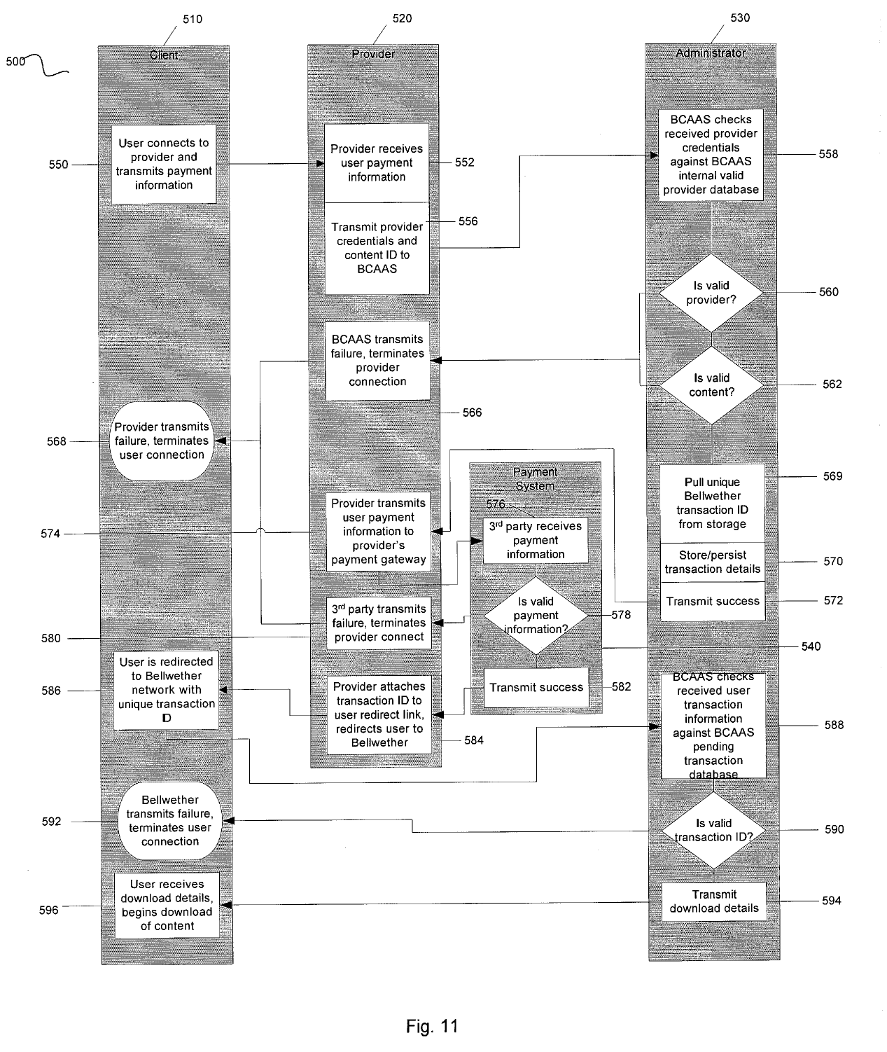

FIG. 11 shows a second exemplary process 500 for user authentication for access to paid content. In this exemplary embodiment, the steps performed by the user are shown in the client box 510, the steps performed by the content provider are shown in the provider box 520, the steps performed by the P2P administrator are shown in the administrator box 530 and the steps performed by the third party payment system are shown in payment system box 540. The content provider is the data provider 2 shown in FIG. 1, the P2P administrator is the administrator 4 shown in FIG. 1 and the user is the requestor 8 shown in FIG. 1. The third party payment system is not shown in FIG. 1. The steps of process 500 are generally similar to the steps of the process 400 having corresponding numbers (e.g., step 450 of process 400 is generally similar to step 550 of process 500). Thus, these steps will only be briefly described because additional information for these steps has been provided above. However, those steps that are different will be described in more detail.

In a first step 550, the user connects to the content provider by, for example, accessing a web page of the content provider. The accessing of the web page may also include a content request that includes information such as a content ID (i.e., an identification of the particular content that the user desires to access) and payment information for the content such as credit card information. In step 552, the content provider receives the content request including the content ID and the payment information. The content provider then transmits the provider credentials and the content ID to the administrator (step 556). It is noted that in process 400, the content provider also generated a transaction ID and transmitted the transaction ID to the administrator. However, this step is omitted from the process 500.

In step 558, the administrator receives the information from the content provider and determines if the content request is valid. For example, in step 560, the administrator may compare the received provider credentials to a list of valid provider credentials in a provider credential database. In step 562, the administrator may compare the received content ID to a list of valid content for the identified content provider in a provider content database. If any of the steps 560-562 results in an invalid request, the content provider is notified of the error and the connection between the content provider and the administrator is terminated (step 566). In turn, the user is notified of the error and the connection between the user and the content provider is terminated (step 568).

If the content request is valid, in contrast to the process 400, the process 500 includes step 569 where the administrator assigns a unique transaction ID to the valid transaction. In one example, the administrator generates a unique 64 byte alphanumeric key for the transaction ID. The administrator then stores the transaction details for further use (step 570). The transaction details may include the valid transaction ID and the content ID. The administrator then transmits the successful validation of the content request to the content provider (step 572).

Upon receiving confirmation that the content request is valid, the content provider sends the payment information to the third party payment system (step 574). The third party payment system receives the payment information (step 576) and determines if the payment information is valid (step 578). If the payment information is invalid, the content provider is notified of the error and the connection between the content provider and the administrator is terminated (step 580). In turn, the user is notified of the error and the connection between the user and the content provider is terminated (step 568). If the payment information is valid, the third party payment system transmits a successful validation of the payment information to the content provider (step 582). The content provider then sends the transaction ID to the user including a link to redirect the user to the administrator's site (step 584).

The user receives the transaction ID and is redirected to the administrator's site (step 586). When the user is redirected to the administrator site, the transaction ID is sent from the user to the administrator. In step 588, the administrator receives the transaction ID and compares the received transaction ID to the previously stored transaction IDs (e.g., the transaction ID of the transactions details stored in step 570). If the received transaction ID does not match a valid pending transaction ID (step 590), the user is notified in step 592 and the connection to the administrator is terminated. If the transaction ID is validated (step 590), the administrator retrieves the download details and transmits a message (e.g., message 46 of FIG. 1) including the download details for the requested content to the user (step 594). The user receives the download details and then contacts the distribution apparatuses to begin download of the requested content (step 596).

FIG. 5 illustrates a process by which a distribution apparatus 6 provides information 100 to the administrator apparatus 4. A distribution apparatus may be always-on or sometimes-on. An always-on distribution apparatus (a drone peer) may send information 100 periodically or whenever a trigger event occurs. As the drone peer is always on, the information 100 typically informs the administration apparatus of its available 5 resources, such as available memory for use and available bandwidth for use. It may also inform the administrator apparatus 4 of a change in IP address.

A sometimes-on distribution apparatus (a peer) will send information 100 when it is switched on and ready to participate in the system 10 and may subsequently send information 100 periodically or whenever a trigger event occurs or when the peer is no longer able to participate in the system. As the peer is not always on, the information 100 typically may either inform the administration apparatus 4 of its available resources such as available memory for use and available bandwidth for use or of its availability (e.g., that it has joined the system 10 or is leaving the system 10). It may also inform the administration apparatus 4 of a change in IP address.

An always-on distribution apparatus 6 may be dedicated to distribution of fragments within the network and be owned and controller by the owners/controllers of the administrator apparatus 4. A sometimes-on distribution apparatus 6 will not be a dedicated to distribution of fragments within the network and is generally owned and controller by someone other than the owners/controllers of the administrator apparatus 4, such as a user of the system. A sometimes-on distribution apparatus 6 may be created from a requester apparatus as described in relation to FIG. 1.

The information 100 provides the administration apparatus 4 with information that enables it to optimize the data delivery service provided by the system 10 and, in particular, to optimize the content of the message 46 which instructs a requestor apparatus 8 which distribution apparatuses 6 should be accessed to obtain a particular fragment. As will be appreciated from the foregoing, a record 33 for a data structure 12 may have multiple entries for a single fragment. Each entry may identify a different distribution apparatus at which that fragment is stored. The administration apparatus 4 may select a sub-set of those multiple entries, so that, for example, only entries relating to available or active distribution apparatuses 6 are included. The administration apparatus may prioritize the multiple entries, based on the prior use of the distribution apparatuses 6 associated with the entries and based on the resources of the distribution apparatuses 6 associated with the entries.

Typically, the distribution of a new data structure 12 starts by dispersing fragments F only to the dedicated, always-on distribution apparatuses (drone peers). With each subsequent download of the data structure 12 by a data requestor apparatus 8, a new distribution apparatus (peer) is created for some, but not all, of the fragments used to create the data structure. In one implementation, a distribution apparatus can only store a single fragment of any one data structure. Thus, with each download the system 10 for that data structure expands to form a peer-to-peer network with access controlled by the administrator apparatus 4.

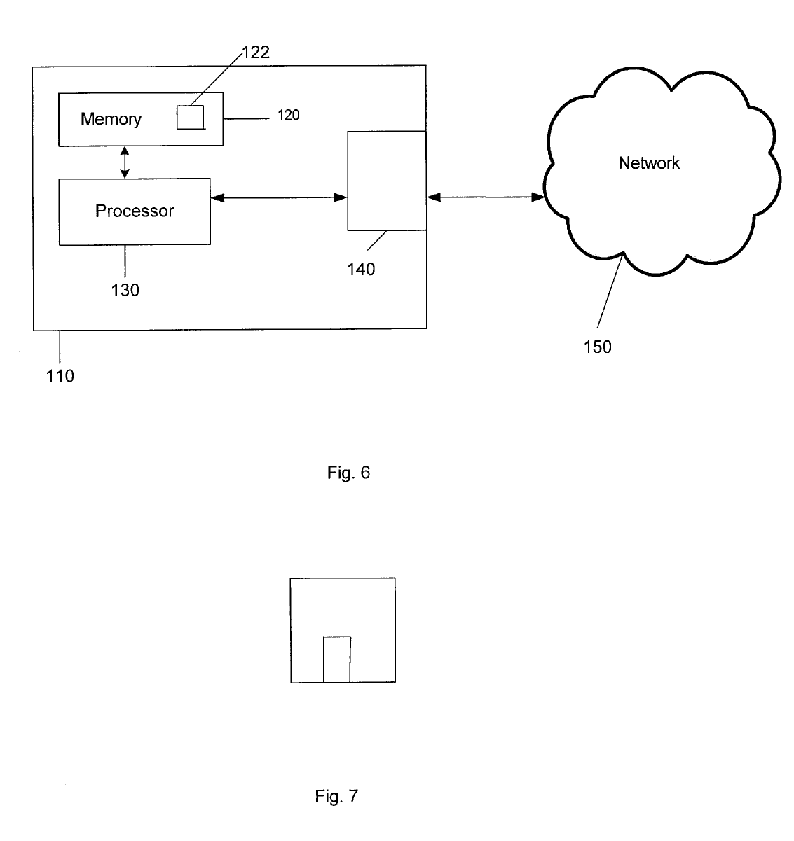

FIG. 6 schematically illustrates an apparatus 110 operable as the requester apparatus 8, a distribution apparatus 6, the administration apparatus 4 or the data provider apparatus 2. The apparatus 110 comprises a processor 130, a memory 120 and a communications interface 140. The processor 130 may be any suitable processing circuitry (e.g., a microprocessor). The memory 120 may be written to and read from by the processor 130. The communications interface 140 is for connection to a network 150 (e.g., the Internet) and is used to transmit and receive the messages illustrated in FIGS. 1 and 4. The processor 130 is able to process messages received at the communications interface 140 from the network 150 and is operable to create messages for sending into the network 150 via the communications interface 140. The capability of the apparatus 110 depends upon a computer program 122 stored in the memory 120.

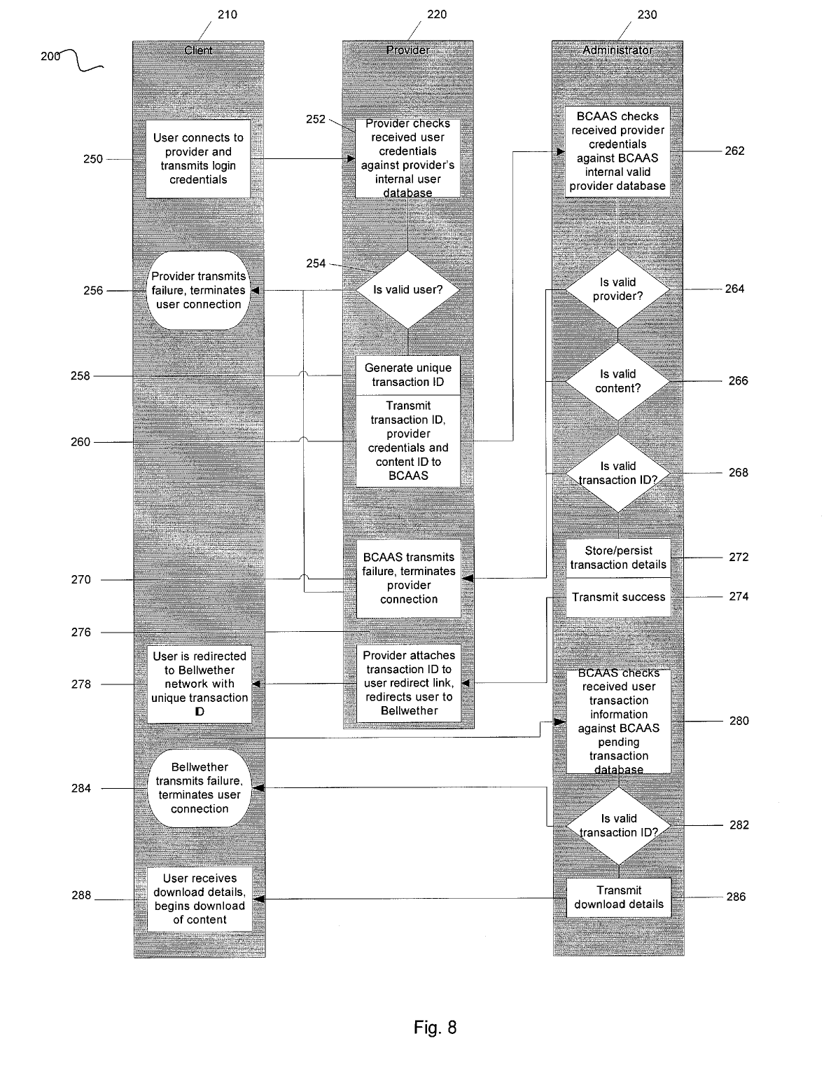

One exemplary computer program 1 22A may be used to control the apparatus 110 to operate as both a requester apparatus 8 and a distribution apparatus 6. The computer program, when downloaded onto an apparatus 110, is initially in a “requester only mode” and enables the apparatus 110 to operate as a requestor apparatus 8. After downloading a data structure 12, the apparatus 110 then enters a “distribution mode” and is operable both as a distribution apparatus for a data fragment of the downloaded data structure and as a requester apparatus 8 for additional data structures. The computer program instructions 122A control the operation of the apparatus 110 when loaded into the processor 130. The computer program instructions 122A provide the logic and routines that enable the electronic apparatus to perform the methods described above and illustrated in FIGS. 1, 3 and 5 that are performed by a requester apparatus 8 and/or a distribution apparatus 6. The computer program instructions 122A may arrive at the apparatus 110 via an electromagnetic carrier signal (e.g., via the network 150) or may be copied from a physical entity 160 (shown in FIG. 7) such as a computer program product, a memory device or a recording medium such as a CD-ROM or DVD.

Another exemplary computer program 122B may be loaded into memory 120 as an alternative to computer program 122A. The computer program instructions 122B control the operation of the apparatus 110 when loaded into the processor 130. The computer program instructions 122B provide the logic and routines that enables the apparatus 110 to perform the methods described above and illustrated in FIGS. 1, 2, 4 and 5 that are performed by an administrator apparatus 4. The computer program instructions 122B may arrive at the apparatus 110 via an electromagnetic carrier signal (e.g., via the network 150) or may be copied from a physical entity 160 (shown in FIG. 7) such as a computer program product, a memory device or a recording medium such as a CD-ROM or DVD.

Those skilled in the art will understand that the above-described exemplary embodiments may be implemented in any number of manners, including as a separate software module, as a combination of hardware and software, etc. For example, the administrator 4 may be a server including a memory for storing a set of instructions and a processor for executing the instructions. When the processor executes the instructions, the server may perform the tasks described above for the administrator 4.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A method, comprising:
receiving a content request for content from a content provider, the request including a content provider identification identifying the content provider and a content identification identifying the content;
validating the content provider based on the content provider identification;
validating the content based on the content identification; and
storing, after successful validation of the content provider and the content, transaction details corresponding to the content request.

2. The method of claim 1, wherein the transaction details include a transaction identification.

3. The method of claim 2, further comprising:
generating the transaction identification.

4. The method of claim 2, wherein the transaction identification is included in the content request.

5. The method of claim 4, further comprising:
validating the transaction identification.

6. The method of claim 2, further comprising:
receiving a message including the transaction identification;
correlating the transaction identification to the stored transaction details;
retrieving content information corresponding to the content identification; and
transmitting the content information to a user.

7. The method of claim 1, further comprising:
transmitting, after successful validation of the content provider and the content, a validation message to the content provider.

8. The method of claim 6, wherein the content information includes a listing of locations for a plurality of fragments of the content.

9. The method of claim 1, wherein the content is stored on a plurality of peer devices, each of the peer devices including a fragment of the content.

10. A method, comprising:
receiving a content request for content from a user, the request including a user identification and a content identification identifying the content;
validating the user based on the user identification;
generating a further content request for the content, the request including a content provider identification identifying the content provider and the content identification identifying the content; and
transmitting the further content request.

11. The method of claim 10, further comprising:
receiving a response to the further content request, the response including a transaction identification for the content request; and
transmitting the transaction identification to the user.

12. The method of claim 11, wherein the transaction identification is generated as a portion of the further content request.

13. The method of claim 10, further comprising:
receiving payment information from the user;
transmitting a payment authorization request including the payment information, the payment authorization request being transmitted to a different entity from the further content request.

14. The method of claim 13, further comprising:
receiving a payment authorization response.

15. A system, comprising:
a content provider receiving a content request for content from a user, the request including a user identification and a content identification identifying the content, validating the user based on the user identification, generating a further content request for the content, the request including a content provider identification identifying the content provider and the content identification identifying the content and transmitting the further content request; and
an administrator receiving the further content request from the content provider, validating the content provider based on the content provider identification, validating the content based on the content identification and storing, after successful validation of the content provider and the content, transaction details corresponding to the content request.

16. The system of claim 15, wherein the transaction details include a transaction identification.

17. The system of claim 16, wherein the administrator further receives a message including the transaction identification from the user, correlates the transaction identification to the stored transaction details, retrieves content information corresponding to the content identification and transmits the content information to the user.

18. The system of claim 15, wherein the administrator further transmits, after successful validation of the content provider and the content, a validation message to the content provider.

19. The method of claim 15, wherein the content is stored on a plurality of peer devices, each of the peer devices including a fragment of the content, the content information including a listing of locations for at least a portion of the plurality of peer devices including the fragments.

20. A system comprising a memory storing a set of instructions and a processor for executing the instructions, the instructions being operable to:
receive a content request for content from a content provider, the request including a content provider identification identifying the content provider and a content identification identifying the content;
validate the content provider based on the content provider identification;
validate the content based on the content identification; and
store, after successful validation of the content provider and the content, transaction details corresponding to the content request.
